(19) United States
(12) Patent Application Publication
(10) Pub. No.: US 2012/0242650 A1
(43) Pub. Date: Sep. 27, 2012

(54) 3D GLASS, 3D IMAGE PROCESSING METHOD, COMPUTER READABLE STORAGE MEDIA CAN PERFORM THE 3D IMAGE PROCESSING METHOD

(76) Inventors: Yu-Yeh Chen, Taipei City (TW); Jia-Jio Huang, Hsinchu City (TW); Jhen-Wei He, Hualien County (TW); Heng-Shun Kuan, Hsinchu City (TW); Tsung-Hsien Lin, Yunlin County (TW)

(21) Appl. No.: 13/070,490

(22) Filed: Mar. 24, 2011

(51) Int. Cl. G06T 15/00

(52) U.S. Cl. 345/419

(57) ABSTRACT

A 3D image processing method, for processing a dynamic image region swapping between a first dynamic image gray level and a second dynamic image gray level, comprising: determining a max dynamic gray level reference value and a min dynamic gray level reference value, to generate an adjusted dynamic gray level and luminance curve; generating a dynamic table, which includes relations between the adjusted dynamic gray level and luminance curve, the first and second dynamic image gray level, according to the adjusted gray level and luminance curve; and adjusting the first and second dynamic image gray level according to the dynamic table.

### BACKGROUND OF THE INVENTION

1. Field of the Invention

The present invention relates to a 3D image processing method, and particularly relates to a 3D image processing method, which adjusts a gray level and luminance curve and correspondingly adjusts the output gray level of the image. The present invention also discloses a 3D glass that can collocate with the 3D image processing method to reach a better 3D image effect, and further discloses a computer readable storage media that can perform the 3D image process method.

2. Description of the Prior Art

3D image technology utilizes image parallax of the left and right eyes to compose a 3D image. For example, in FIG. 1, the image 101 sawn by the left eye and the image 107 sawn by the right eye, can compose a 3D image. However, such image may be interfered, such that an unclear 3D image or an image should not appear is generated.

For example, in an image of the left eye, images 103 and 105 that should not appear in the left eye image may appear. Similarly, in an image of the right eye, images 109 and 111 that should not appear in the right eye image may appear. By this way, when the images of the right eye and the left eye are composed, images 103, 105, 109 and 111 may cause interference to the 3D image that is really desired to be presented, and an incomplete 3D image may be generated. Besides, since part of the images 101 and 107 should be continuously switched between bright and dark gray levels, the images are called dynamic image parts. The image 104 is always kept at a constant gray level, thus is so called a still image part or a background image part.

The possible forming reasons of the images 103, 105, 109 and 111 in FIG. 1 can be shown as FIG. 2. FIG. 2 illustrates prior art steps of scanning an image. As shown in FIG. 2, an idea scanning wave is ideally a square wave and is charged momently. However, there is delay for the charging wave, due to the LC (liquid crystal) characteristics. A transistor with a larger size is needed to reduce charging time, if such problem is desired to be solved. In this case, the transistor may occupy a larger size and reduces light transmittance of the panel.

Additionally, if the image of a specific eye is desired to be generated (ex. the left eye image shown in FIG. 1), all the scan lines 201 should be all scanned. Waiting time DT will exist between the timing that all the scan lines 201 are scanned and the timing that the scanning of the next eye image begins. However, due to the existence of waiting time DT, the scanning time of the scan lines 201 should be shorten such that the operation speed of the circuit can be quick enough. The shortened scanning time increases the complexity for designing a circuit, thus the probability for composing bad 3D image is increased.

### SUMMARY OF THE INVENTION

One objective of the present invention is to disclose a 3D image processing method, to decrease interference between images of two eyes, to decrease delay time between the scanning operations for images of two eyes.

One embodiment of the present invention discloses a 3D image processing method, for processing a dynamic image region, wherein the dynamic image region is switched between a first dynamic image gray level and a second dynamic image gray level. The 3D image processing method is applied to a 3D image processing system and comprises: determining a max dynamic reference gray level and a min dynamic reference gray level of a dynamic gray level and luminance curve, to generate an adjusted dynamic gray level and luminance curve; generating a dynamic table, which includes relations between the adjusted dynamic gray level and luminance curve, the first and the second dynamic image gray level, according to the adjusted gray level and luminance curve; and adjusting the first and second dynamic image gray levels according to the dynamic table. Another embodiment of the present application discloses a computer readable recording media storing program, when a computer loads and executes the program, a 3D image processing method for processing a dynamic image region can be performed.

Another embodiment of the present application discloses a 3D image processing method, applied to a 3D image processing system comprising a 3D glass, a display and a detector. The 3D image processing method comprises: utilizing the detector to detect a distance between a 3D glass and a display, and a tilt level between the display and the 3D glass, to determine a turn on time period of the 3D glass.

In view of above-mentioned embodiment, the interference between the left eye image and the right eye image can be decreased. Also, the delay time between image scanning operation of two eyes. By this way, the necessary speed of the circuit can be decreased, and simply the design. Furthermore, transistors with large sizes are no longer needed, thereby the yield of panels and light penetration rate can be improved.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram illustrating prior art images of the right eye and the left eye.

FIG. 2 illustrates prior art image scanning operation.

FIG. 3 is a schematic diagram illustrating prior art max, min gray levels and luminance of the dynamic image part.

FIG. 4 is a schematic diagram illustrating max, min gray levels of the dynamic image part, and a dynamic gamma curve adjusted by a 3D image processing method according to an embodiment of the present application.

FIG. 5 is a schematic diagram illustrating gray level of the still image part, and a dynamic gamma curve adjusted by a 3D image processing method according to an embodiment of the present application.

FIGS. 6A, 6B and 6C are schematic diagrams illustrating the operations of adjusting the still gamma curve to be substantially the same with the dynamic gamma curve.

FIG. 7 is a schematic diagram illustrating the operations of adjusting the dynamic gamma curve to be substantially the same with the still gamma curve.

FIG. 8 is a flow chart illustrating a 3D image processing method according to an embodiment of the present application.

FIG. 9 is a schematic diagram illustrating the situation that turn on time of the 3D glass is adjusted.

FIG. 10 is a 3D image processing system utilizing the 3D image processing method, according to an embodiment of the present application.

FIG. 11 is a schematic diagram illustrating how to adjust the 3D glass utilizing the 3D image processing method according to an embodiment of the present application.

FIG. 12 is a schematic diagram illustrating a 3D glass according to an embodiment of the present application.

### DETAILED DESCRIPTION

Certain terms are used throughout the description and following claims to refer to particular components. As one skilled in the art will appreciate, electronic equipment manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

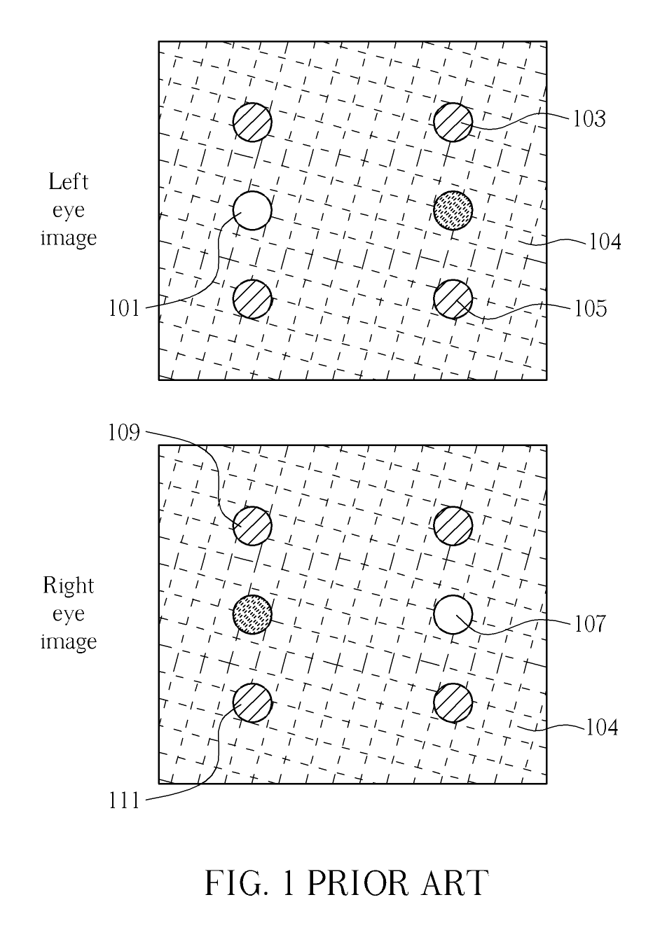

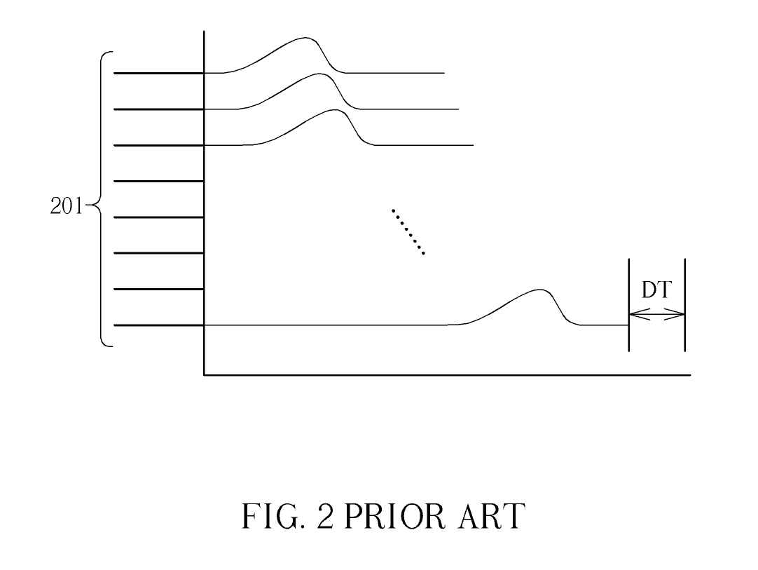

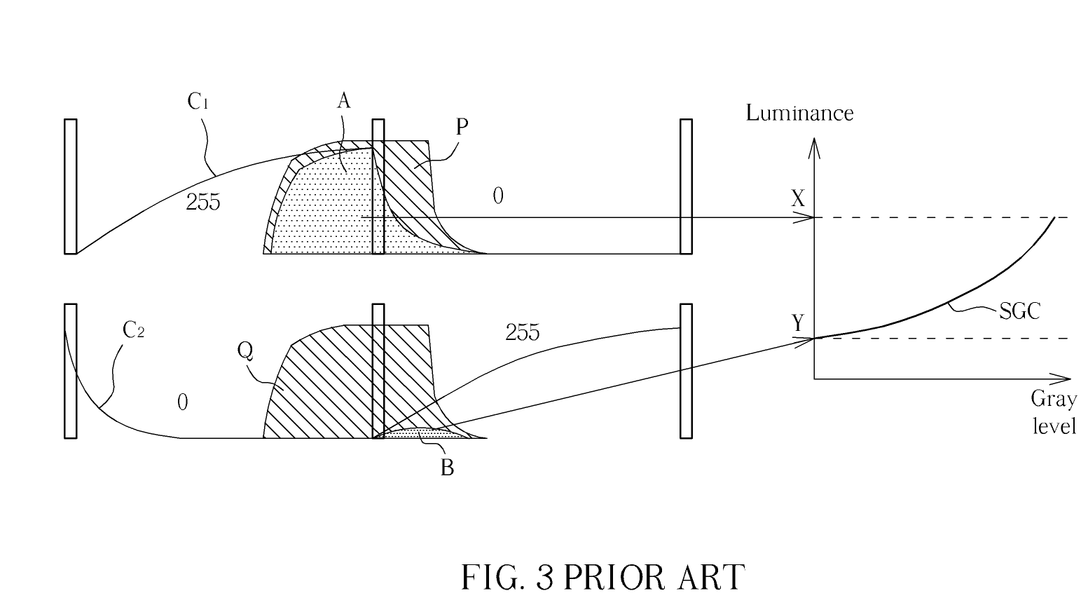

FIG. 3 is a schematic diagram illustrating prior art max, min gray levels and luminance of the dynamic image part. FIG. 3 illustrates the operation that the dynamic image part shown in FIG. 1 is switched between two gray levels (in this embodiment, switch between gray level 0 and gray level 255). C1 curve and C2 curve indicate a LC (liquid crystal) optical curve formed by switching operation of panel LCs. Besides, P curve and Q curve indicate a glass optical curve formed by switching operation of glass light transparent regions. Besides, A region and B region respectively indicate light transparent regions that are formed by multiplying LC optical curves C1, C2 and the P curve, the Q curve. The light transparent region indicates light penetration amount. That is, the total light penetration amount is determined by the time period that both the LC and the glass are light transparent.

The total area of regions A and B must meet the luminance and gray level requirement of the corresponding points X and Y at the dynamic gamma curve SGC. However, as described above, since the scanning time is shortened, the problem shown in FIG. 1 may easily occur if a switch operation is performed between luminance levels with large difference. Accordingly, a 3D image processing method is provided by the present application to improve this situation. Gamma curve is a curve indicating the relations of gray level and luminance in a display. Other details of gamma curve is well known in prior art, thus it is omitted here for brevity.

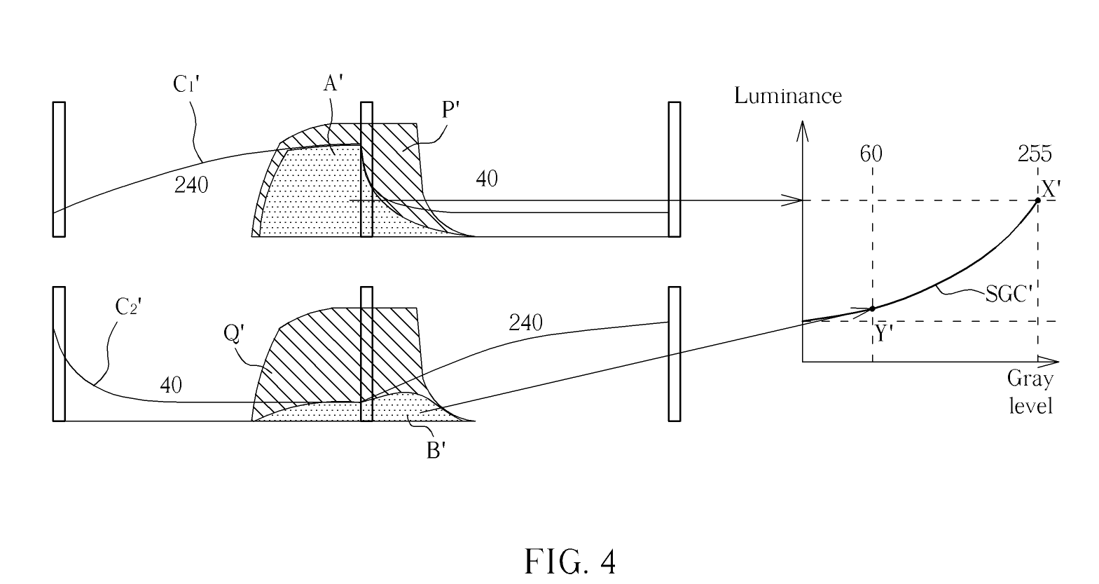

FIG. 4 is a schematic diagram illustrating a 3D image processing method of an embodiment of the present application. This 3D image processing method adjusts the max gray level and the min gray level of the dynamic gamma curve, and the dynamic image part. In the embodiment shown in FIG. 4, a dynamic gamma curve SGC (i.e. a luminance and gray level relation curve) is determined first, to form an adjusted dynamic gamma curve SGC′. Then, the light transparent regions A′ and B′ are generated via multiplying LC optical curves C1′, C2′ and, P′ curve, Q′ curve. The transparent regions A′ and B′ must meet requirements of X′, Y′ points of the adjusted gamma curve SGC′. Therefore, the two gray levels that the dynamic image region switch between must be determined by the adjusted gamma curve SGC′. In this embodiment, when the gray levels that the dynamic image region switch between are 240 and 40, the corresponding gray levels at the dynamic gamma curve SGC′ are 255 and 60. Thus, if the adjusted gamma curve SGC′ is determined, no matter what the gray levels that the dynamic image region switch between are, the gray levels can be correspondingly adjusted to meet the adjusted dynamic gamma curve SGC′.

A panel initially has a set of gray level-voltage different distribution. Panel gray level voltages of 255 and 0 are alternatively output each two frames first, and a max vision luminance, a min vision luminance are correspondingly generated at the right eye, the left eye of a user. A new adjusted dynamic gamma curve SGC′ is rebuild according to the max vision luminance and the min vision luminance. For example, in an embodiment, the gamma curve SGC′ is determined by gray level to the power of 2.2. The concept for the operation of 2.2 power of a curve can be shown as following Equation (1):

Vision Luminance Function (Gray level)=(Max vision luminance−Min vision luminance)*(Gray level/Max Gray level)^{2.2})+Min vision luminance

Vision Luminance Function (Gray level)=(Max vision luminance−Min vision luminance)*(New Gray level and Max new Gray level)^{2.2})+Min vision luminance Equation (1)

The new adjusted dynamic gamma curve SGC′ re-determines a relation curve of new gray levels and vision luminance. Accordingly, if the user wishes to acquire vision luminance corresponding to new gray levels 255, 60 of the adjusted dynamic gamma curve SGC′, the gray level voltages of the panel must be 240 and 40 in turn.

Accordingly, in the embodiment shown in the present application, a dynamic look up table is generated according to the adjusted dynamic gamma curve SGC′. After that, no matter what the gray levels that the dynamic image region switch between are, the gray levels can be correspondingly adjusted accordingly to the look up table. Thus, the 3D image processing method according to the embodiment of the present application is not limited to that the gray levels 255, 0 are adjusted to 240, 40, but also can be adjusted to any group of gray levels to another group of gray levels. Besides, the max dynamic reference gray level and the min dynamic reference gray level of the adjusted dynamic gamma curve SGC′ are not limited to 255 and 60.

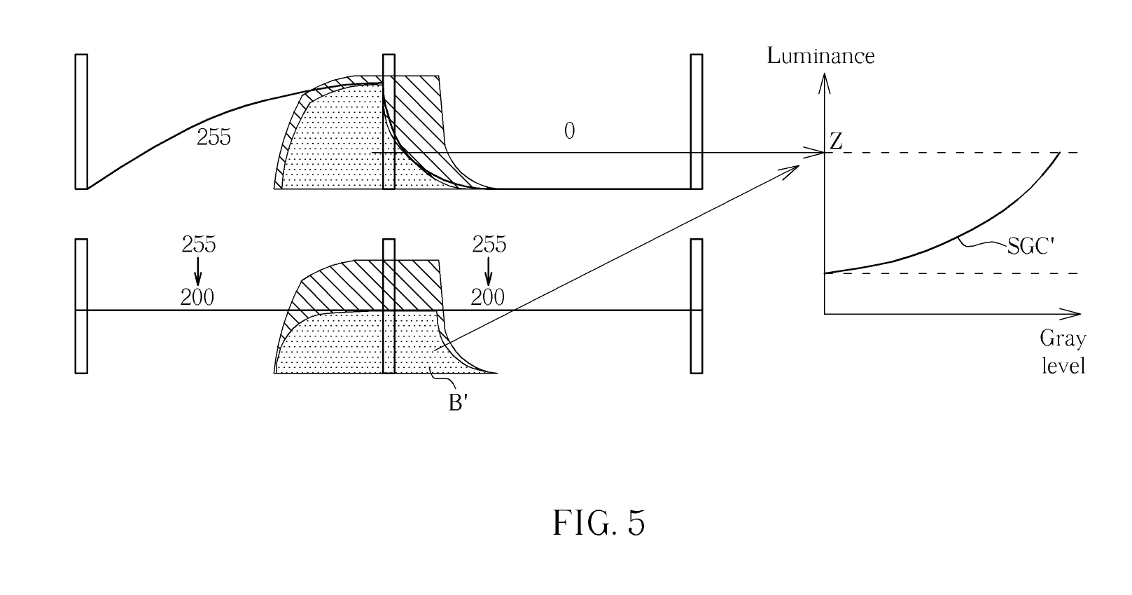

Not only the gray level of the dynamic image region needs to be adjusted, the gray levels of the still image region can also be adjusted corresponding to the adjusted dynamic gamma curve SGC′, such that better 3D image effect can be acquired. In the embodiment shown in FIG. 5, a gray level of the still image region, which is initially 255, will be adjusted to 200 to meet the requirement of a Z point of the adjusted dynamic gamma curve SGC′ (gray level 255). Therefore, in an embodiment of the present application, a still look up table will be generated according to the adjusted dynamic gamma curve SGC′, and thereby any gray level of the still image region can be correspondingly adjusted. Apparent isolation can be formed between images that are desired to be displayed and images that are not desired to be displayed, via adjusting gray levels of the dynamic image region and the still image level. By this way, delay time between the scanning operations of images for two eyes (i.e DT in FIG. 1) can be effectively decreased. The above mentioned static look up table and dynamic look up table can be simplified (ex. images with less variation). By this way, detail look up tables including large data amount can be removed. One implementation is combining a plurality of gray levels into a single group of gray levels. Alternatively, interpolation or other mathematic functions can be performed to simply the concept of look up tables.

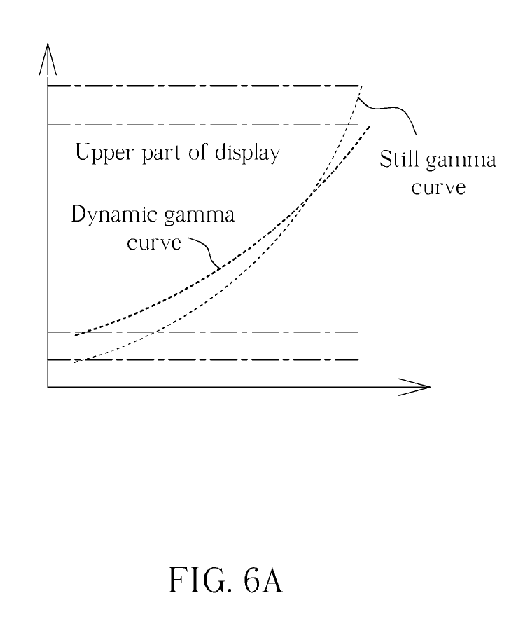

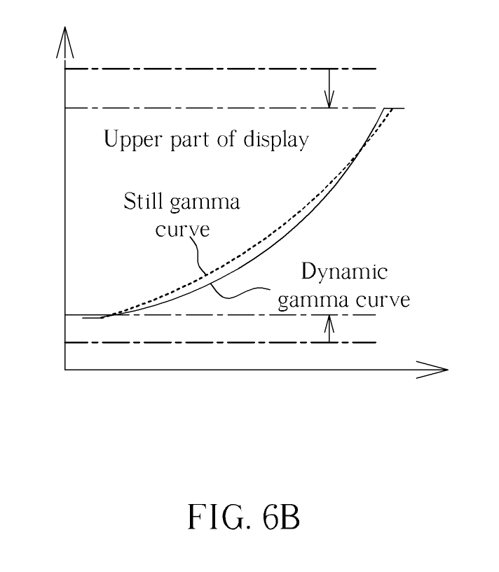

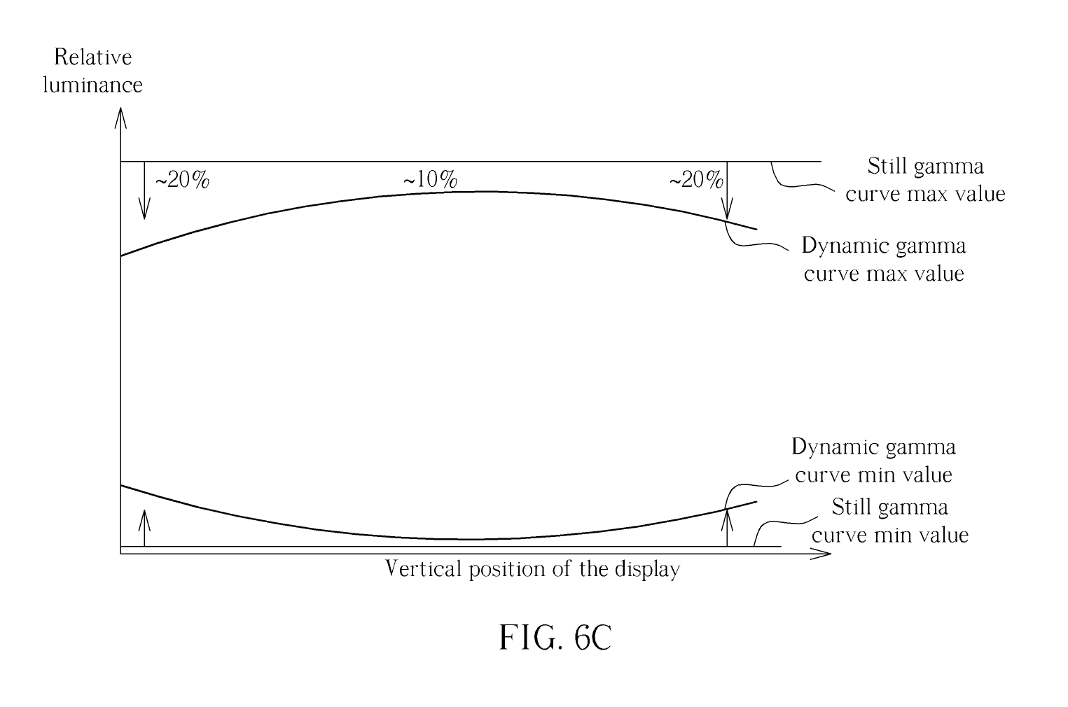

A still gamma curve can be acquired via the still look up table. One embodiment of the present application provides performing at least one of a first step and a second step to improve 3D image quality. The first step includes: adjusting the adjusted dynamic gray level, such that the adjusted dynamic gray level is substantially the same with the still gray level. The second step includes: adjusting the still gamma curve, such that the still gamma curve is substantially the same with the adjusted dynamic gray level. FIGS. 6A, and 6B are schematic diagrams illustrating the operations of adjusting the still gamma curve to be substantially the same with the dynamic gamma curve. The practical steps can be shown as FIG. 6C. Since there are more still image regions distributed at the upper part and the lower part of the display, luminance of the still image region can be pulled up or pulled down such that the luminance of the dynamic image region and the still image region can be substantial the same. By this way, delay time between the scanning operations of images for two eyes (i.e DT in FIG. 1) can be effectively decreased.

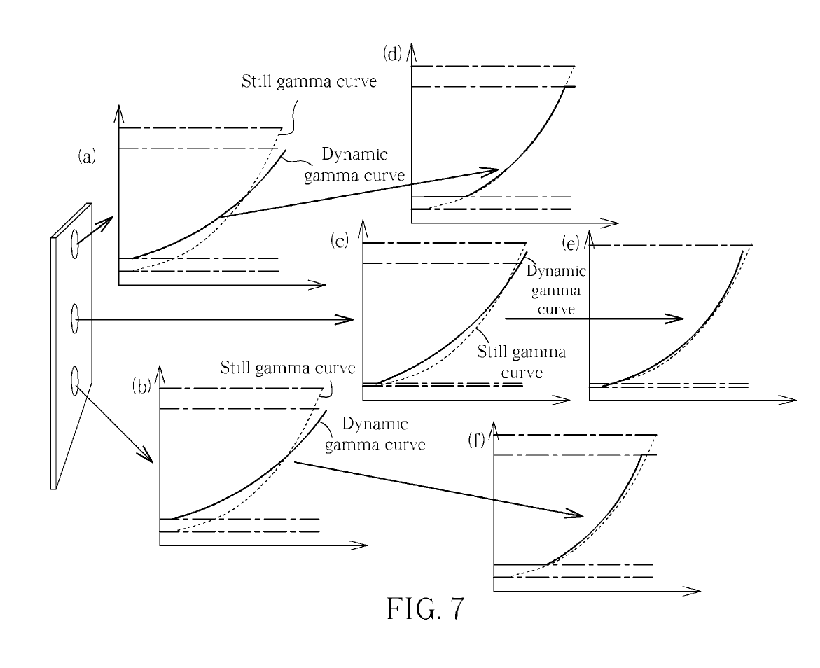

FIG. 7 is a schematic diagram illustrating the operations of adjusting the dynamic gamma curve to be substantially the same with the still gamma curve. As shown in FIG. 7, such method will perform different performance to the upper part (FIG (a) in FIG. 7), the middle part (FIG (c) in FIG. 7) and the bottom part (FIG (b) in FIG. 7) of a display. Normally, the middle part of the display has better performance (FIGs (c) and (e) in FIG. 7). Thus, in the embodiment of the present application, which one of the processing methods shown in FIG. 6 (adjusting the still gamma curve, such that the still gamma curve is substantially the same with the adjusted dynamic gray level, such as FIG (d) in FIG. 7) and FIG. 7 (adjusting the adjusted dynamic gray level, such that the adjusted dynamic gray level, such as FIG (f) in FIG. 7) should be performed can be determined according to original gray level or the display location of a display.

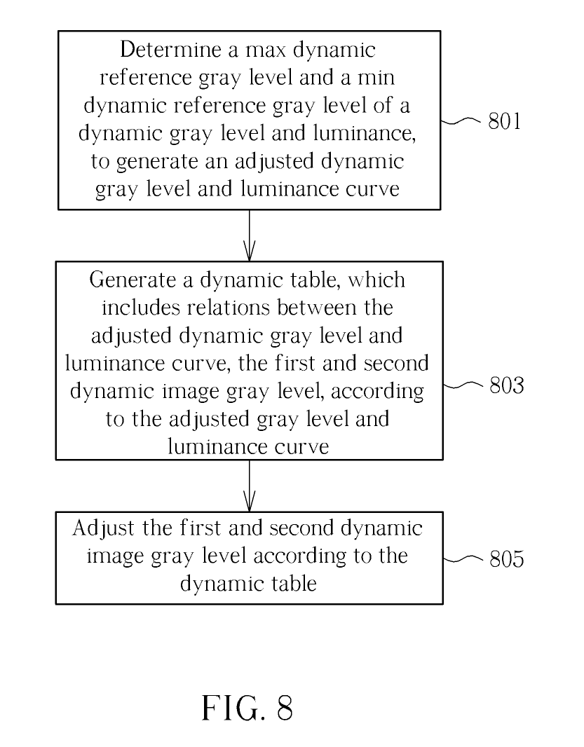

The embodiment shown in FIG. 4 can be written as the 3D image processing method shown in FIG. 8.

Step 801

Determine a max dynamic reference gray level and a min dynamic reference gray level of a dynamic gray level and luminance, to generate an adjusted dynamic gray level and luminance curve

Step 803

Generate a dynamic table, which includes relations between the adjusted dynamic gray level and luminance curve, the first and second dynamic image gray level (ex; gray levels 255, 0 shown in FIG. 3), according to the adjusted gray level and luminance curve.

Step 805

Adjust the first and second dynamic image gray level according to the dynamic table (ex; adjust 255, 0 to 240, 40).

Corresponding to the embodiment shown in FIG. 5, the steps shown in FIG. 8 can further comprise the following steps: generate a still table according to the adjusted dynamic gray level and luminance curve, where the still table includes relations between the adjusted dynamic gray level and luminance curve, and a still image gray level.

Corresponding to the embodiments shown in FIGS. 6 and 7, the steps shown in FIG. 8 can further comprise: performing at least one of a first step and a second step as follows:

first step: adjusting the adjusted dynamic gray level and luminance curve, such that the adjusted dynamic gray level and luminance curve is substantially the same with the still gray level and luminance curve;

second step: adjusting the still gray level and luminance curve, such that the still gray level and luminance curve is substantially the same with the adjusted dynamic gray level and luminance curve.

The abovementioned embodiments can be performed via firmware cooperating with hardware, or a micro processor in a 3D image processing system. Alternatively, the embodiments can be performed by programs recorded in a computer readable recording medium.

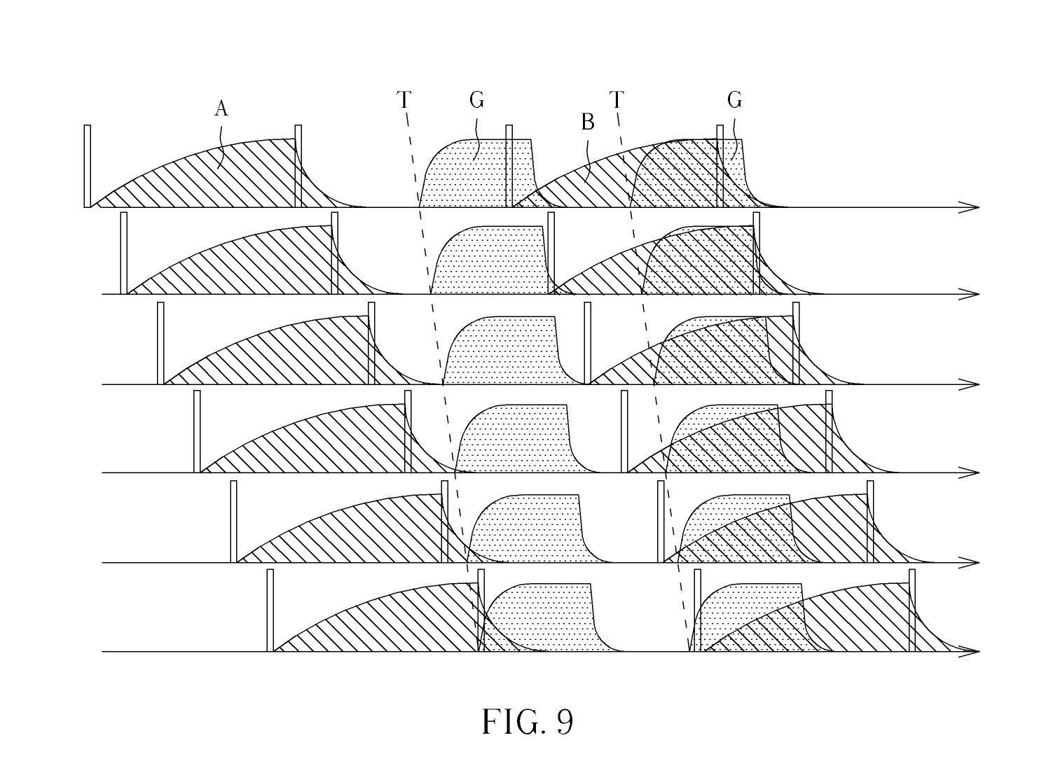

The present application also provides another 3D image processing method which controls a 3D glass to acquire a better 3D image. This 3D image processing method can be applied with above-mentioned 3D image processing method, but also can be independently utilized. FIG. 9 is a schematic diagram illustrating the situation that turn on time of the 3D glass is adjusted. As shown in FIG. 9, the LC optical curves A and B may have poor waveforms due to LC response time or other factors. Also, the distance between the 3D glass and the display or tilt level may change if the user wear the 3D glass. The variation of the distance or the tilt level may change the optical effect from LC to a user. Accordingly, timing of glass optical curve can be adjusted to give the user a better 3D image. As shown in FIG. 9, if turn on time period of the 3D glass is not adjusted, the turn on time axis T should be vertical. However, after adjusting, the turn on time axis T is tilted.

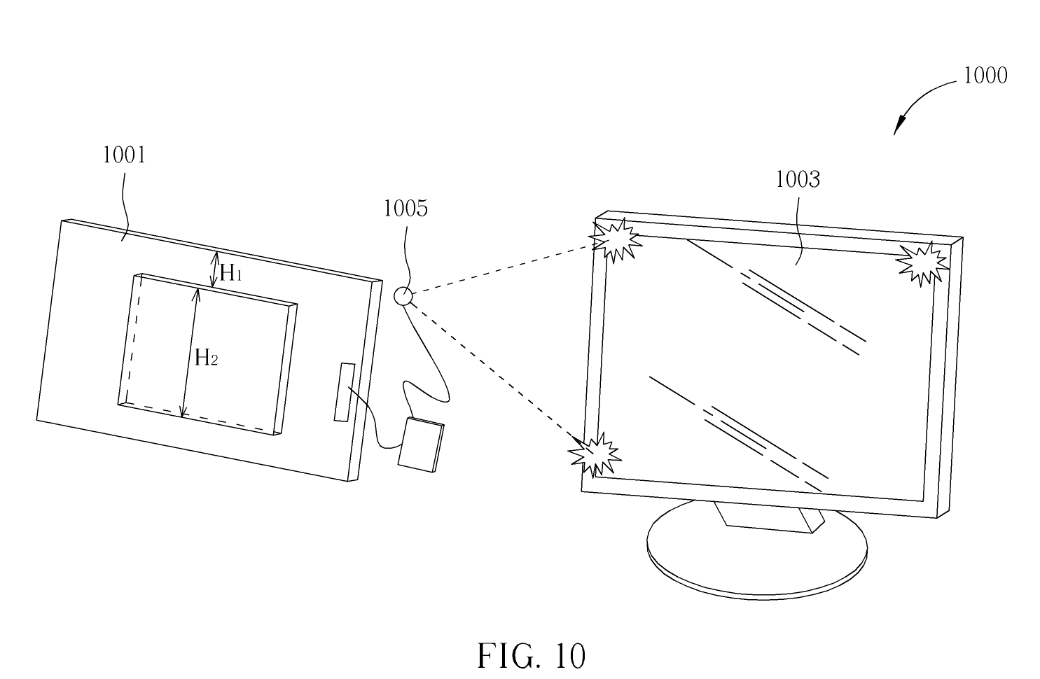

FIG. 10 is a 3D image processing system utilizing the 3D image processing method, according to an embodiment of the present application. As shown in FIG. 10, the 3D image processing system 1000 includes a 3D glass 1001, a display 1003 and a detector 1005. The 3D image processing method according to the present application includes: utilizing the detector 1005 to detect a distance between a 3D glass 1001 and a display 1003, and a tilt level between the display and the 3D glass, to determine a turn on time period of the 3D glass.

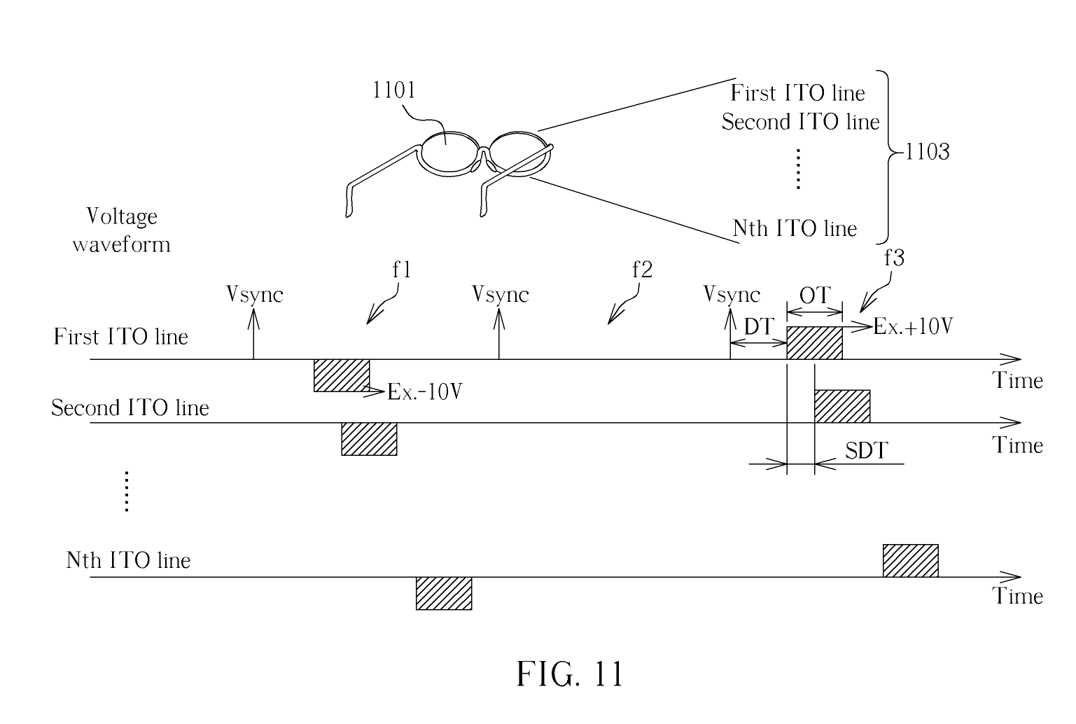

FIG. 11 is a schematic diagram illustrating how to adjust the 3D glass utilizing the 3D image processing method according to an embodiment of the present application. As shown in FIG. 11, the 3D glass 1101 has a plurality of ITO (Indium Tin Oxide) lines, which turn on when a voltage applied thereon reaches a positive turn on voltage or a negative turn on voltage (in this embodiment, positive 10 volt and negative 10 volt). The signal Vsync in FIG. 10 is a vertical Sync signal, which indicates a starting of a frame. Accordingly, the time period between two Vsyncs indicates the time period of a frame. The reason for the empty of a time axis for the second frame is: the left eye and the right eye of the 3D glass must turn on in turn, thus if one eye of the 3D glass turns on in a time period of the first frame f1, the other eye of the 3D glass turns on when the second frame f2 begins. Three time parameters must be controlled when turn on time of ITO lines is desired to be controlled. One if turn on time OT, one is delay time DT from Vsync to turn on voltage, and the last one is the vice delay time SDT between two ITO lines. Thus, according to a 3D image processing method of an embodiment of the present invention, the detector 1005 is utilized to detect a distance between the 3D glass 1001 and the display 1003, and a tilt level between the display and the 3D glass 1001, to determine a turn on time period of the 3D glass, such that the turn on time OT, the delay time DT and the vice delay time SDT can be adjusted to acquire better 3D image effect.

In an embodiment, the turn on time OT, the delay time DT and the vice delay time SDT can be determined by following equations:

DT=−H1/H2*Ft

SDT=Ft/(ITO Line Number)

OT<Ft

As shown in FIG. 10, H1 is a width of the 3D glass 1001 in a vertical direction, and H2 is a width of the light transparent part of the 3D glass 1001 in a vertical direction. Also, Ft indicates frame rate.

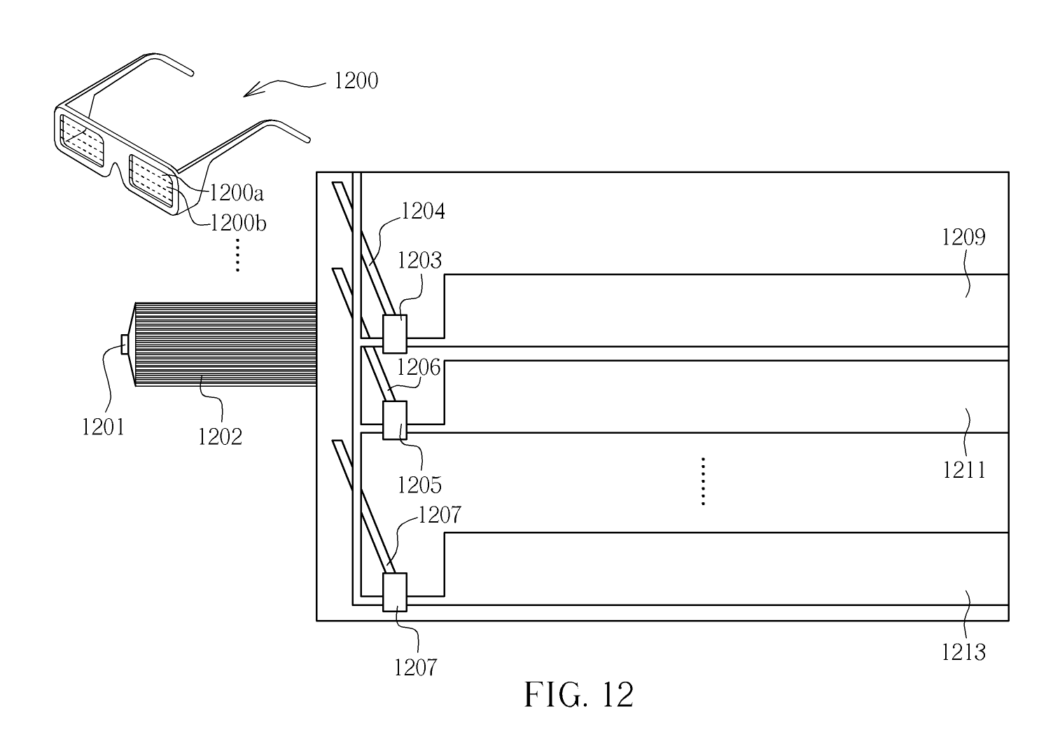

FIG. 12 is a schematic diagram illustrating a 3D glass according to an embodiment of the present application. As shown in FIG. 12, the 3D glass 1200 includes a plurality of 3D glass regions 1200a, 1200b (only two of then are marked by symbols). The 3D glass regions 1200a, 1200b can comprise a scan IC 1201 (or a control IC), a plurality of scan lines (marked as 1202). Scan lines 1204, 1206 and 1208 of the scan lines 1202 are coupled to TFTs (Thin Film Transistor) 1203, 1205, 1207. The TFTs 1203, 1205, 1207 are utilized to control ITO lines 1209, 1211 and 1213. As mentioned above, the ITO lines 1209, 1211 and 1213 can be light transparent or not based on receiving voltages.

One difference between the 3D glass in FIG. 12 and the prior art 3D glass is that the prior art 3D glass is not separated into regions thus the whole 3D glass will be light transparent or not simultaneously. Accordingly, the prior art 3D glass can not perform the operation in FIG. 11. Oppositely, the 3D glass provided by the present application is separated into different regions, thus each region can be independently light transparent or not.

It should be noted that the driving mechanism of the 3D glass in FIG. 12 of the present application is not limited to the driving mechanism shown in FIG. 12. For example, the 3D glass regions 1200a, 1200b are not limited to be controlled by a single scan IC. The 3D glass regions 1200a, 1200b can be controlled by different control ICs. Additionally, the TFTs 1203, 1205, and 1207 of the 3D glass 1200 can be removed, such that the voltages are directly input to the ITO lines 1209, 1211 and 1213 from the control IC to control the ITO lines to be light transparent or not. Such variation should also fall in the scope of the present application.

In view of above-mentioned embodiment, the interference between the left eye image and the right eye image can be decreased. Also, the delay time between image scanning operation of two eyes. By this way, the necessary speed of the circuit can be decreased, and simply the design. Furthermore, transistors with large sizes are no longer needed, thereby the yield of panels and light penetration rate can be improved.

Those skilled in the art will readily observe that numerous modifications and alterations of the device and method may be made while retaining the teachings of the invention.

What is claimed is:

1. A 3D image processing method, for processing a dynamic image region, wherein the dynamic image region is switched between a first dynamic image gray level and a second dynamic image gray level, where the 3D image processing method is applied to a 3D image processing system and comprises:
determining a max dynamic reference gray level and a min dynamic reference gray level of a dynamic gray level and luminance curve, to generate an adjusted dynamic gray level and luminance curve;
generating a dynamic table, which includes relations between the adjusted dynamic gray level and luminance curve, the first and the second dynamic image gray level, according to the adjusted gray level and luminance curve; and
adjusting the first and second dynamic image gray levels according to the dynamic table.

2. The 3D image processing method of claim 1, wherein the max dynamic reference gray level and the min dynamic reference gray level are respectively 255 gray level and 60 gray level, where the first dynamic image gray level and the second dynamic image gray level are respectively 255 gray level and 60 gray level.

3. The 3D image processing method of claim 1, further comprising generating a still table according to the adjusted dynamic gray level and luminance curve, where the still table includes relations between the adjusted dynamic gray level and luminance curve and a still image gray level.

4. The 3D image processing method of claim. 3, wherein the max dynamic reference gray level is 255, and the min dynamic reference gray level is 60, where the still image gray level is 200.

5. The 3D image processing method of claim 3, further comprising determining a still gray level and luminance curve according to the still table.

6. The 3D image processing method of claim 5, further comprising:
performing at least one of a first step and a second step as follows:
first step: adjusting the adjusted dynamic gray level and luminance curve, such that the adjusted dynamic gray level and luminance curve is substantially the same with the still gray level and luminance curve, or;
second step: adjusting the still gray level and luminance curve, such that the still gray level and luminance curve is substantially the same with the adjusted dynamic gray level and luminance curve.

7. The 3D image processing method of claim 6, further comprising:
determining which one of the first step and the second step should be performed, according to an original gray level of an image or an image displaying location of a display.

8. The 3D image processing method of claim 1, further comprising:
utilizing the detector to detect a distance between a 3D glass and a display, and a tilt level between the display and the 3D glass, to determine a turn on time period of the 3D glass.

9. The 3D image processing method of claim 8, wherein the 3D glass comprises:
a plurality of 3D glass regions; and
at least one control IC, for controlling the 3D glass regions to be light transparent or not.

10. The 3D image processing method of claim 8, wherein the turn on time period is smaller than frame frequency of the display.

11. A computer readable recording media storing program, when a computer loads and executes the program, a 3D image processing method for processing a dynamic image region can be performed, wherein the dynamic image region is switched between a first dynamic image gray level and a second dynamic image gray level, where the 3D image processing method comprises:
determining a max dynamic reference gray level and a min dynamic reference gray level of a dynamic gray level and luminance curve, to generate an adjusted dynamic gray level and luminance curve;
generating a dynamic table, which includes relations between the adjusted dynamic gray level and luminance curve, the first and the second dynamic image gray level, according to the adjusted gray level and luminance curve; and
adjusting the first and second dynamic image gray levels according to the dynamic table.

12. The computer readable recording media of claim 11, wherein the max dynamic reference gray level and the min dynamic reference gray level are respectively 255 gray level and 60 gray level, where the first dynamic image gray level and the second dynamic image gray level are respectively 255 gray level and 60 gray level.

13. The computer readable recording media of claim 11, further comprising generating a still table according to the adjusted dynamic gray level and luminance curve, where the still table includes relations between the adjusted dynamic gray level and luminance curve and a still image gray level.

14. The computer readable recording media of claim 13, wherein the max dynamic reference gray level is 255, and the min dynamic reference gray level is 60, where the still image gray level is 200.

15. The computer readable recording media of claim 13, further comprising determining a still gray level and luminance curve according to the still table.

16. The computer readable recording media of claim 15, further comprising:
performing at least one of a first step and a second step as follows:
first step: adjusting the adjusted dynamic gray level and luminance curve, such that the adjusted dynamic gray level and luminance curve is substantially the same with the still gray level and luminance curve, or;
second step: adjusting the still gray level and luminance curve, such that the still gray level and luminance curve is substantially the same with the adjusted dynamic gray level and luminance curve.

17. The computer readable recording media of claim 16, further comprising:
determining which one of the first step and the second step should be performed, according to an original gray level of an image or an image displaying location of a display.

18. The computer readable recording media of claim 11, further comprising:
detecting a distance between a 3D glass and a display, and a tilt level between the display and the 3D glass, to determine a turn on time period of the 3D glass.

19. The computer readable recording media of claim 18, wherein the 3D glass comprises:
a plurality of 3D glass regions; and
at least one control IC, for controlling the 3D glass regions to be transparent or not.

20. The computer readable recording media of claim 18, wherein the turn on time period is smaller than frame frequency of the display.

21. A 3D image processing method, applied to a 3D image processing system comprising a 3D glass, a display and a detector, comprising:
utilizing the detector to detect a distance between a 3D glass and a display, and a tilt level between the display and the 3D glass, to determine a turn on time period of the 3D glass.

22. The 3D image processing method of claim 21, wherein the 3D glass comprises:
a plurality of 3D glass regions; and
at least one control IC, for controlling the 3D glass regions to be transparent or not.

23. The 3D image processing method of claim 21, wherein the turn on time period is smaller than frame frequency of the display.

24. A 3D glass, comprising:
a plurality of 3D glass regions; and
at least one control IC, for controlling the 3D glass regions to be transparent or not.

25. The 3D glass of claim 24, wherein an amount of the control ICs is the same as which of the 3D glass regions, and each of the control ICs corresponds to one of the 3D glass regions.
